(19) United States
(12) Patent Application Publication
(10) Pub. No.: US 2019/0312426 A1
(43) Pub. Date: Oct. 10, 2019

(54) Interface Control Circuit

(71) Applicant: RICHTEK TECHNOLOGY CORPORATION, Zhubei City (TW)

(72) Inventors: Chih-Wei Mu, New Taipei (TW); Chieh-Min Lo, Miaoli (TW); Wei-Chung Chang, Taoyuan (TW)

(21) Appl. No.: 16/247,532

(22) Filed: Jan. 14, 2019

(30) Foreign Application Priority Data
Apr. 4, 2018 (CN) 201810298905.X

(51) Int. Cl. H02H 7/20

(52) U.S. Cl. CPC H02H 7/20; H01R 24/60

(57) ABSTRACT

An interface control circuit includes an interface signal transceiver circuit and a protection circuit. The interface signal transceiver circuit transmits and/or receives an interface signal through a transmission interface which includes at least a first interface pin. The protection circuit includes a switch and a comparison circuit. The switch controls a conduction between the first interface pin and a signal source. The comparison circuit senses a voltage of the first interface pin, and determines whether the voltage of the first interface pin is within a threshold voltage range which corresponds to a foreign object attachment event, whereby the interface signal transceiver circuit is triggered to execute a protection operation.

### CROSS REFERENCE

The present invention claims priority to CN 201810298905.X, filed on Apr. 4, 2018.

### BACKGROUND OF THE INVENTION

### Field of Invention

The present invention relates to an interface control circuit; particularly, it relates to an interface control circuit capable of determining whether a transmission interface is attached by a foreign object, and deciding whether to execute a protection operation accordingly.

### Description of Related Art

Hand-held electronic devices are portable and ready-to-use, and because of such features, they are placed in a wide variety of locations, such as on a dinner table, outdoor locations, or accidentally dropped on the ground, etc. Some of the locations may cause foreign objects such as rain, beverages, dusts, hairs or the like to stick to or infiltrate into the transmission interface of the hand-held electronic device. If the transmission interface containing the foreign object is coupled to another transmission interface, the electrical or electrochemical characteristics of the foreign object can cause signal transmission errors or misjudgments, or worse, the electrochemical reaction can damage the interface circuit or the interface pins. Moreover, high power transmission in the hand-held electronic devices is becoming more and more popular than before; if an electrochemical reaction occurs, the degree of damage caused by the electrochemical reaction is more serious than lower power transmission. Therefore, how to effectively protect the transmission interface from damages caused by a foreign object is an important issue.

### SUMMARY OF THE INVENTION

From one perspective, the present invention provides an interface control circuit, comprising: An interface control circuit, comprising: an interface signal transceiver circuit, configured to operably transmit and/or receive an interface signal through a transmission interface, wherein the transmission interface includes a first interface pin; and a protection circuit, which includes: a switch, configured to control whether the first interface pin is connected with a signal source; and a comparison circuit, configured to sense a voltage of the first interface pin, and determine whether the voltage of the first interface pin is within a threshold voltage range which corresponds to a foreign object attachment event that a foreign object is attached to the first interface pin; wherein when the first interface pin is connected with the signal source and the voltage of the first interface pin is within the voltage threshold range, the interface signal transceiver circuit is triggered to execute a protection operation.

In one embodiment, when the first interface pin is connected with the signal source, the comparison circuit compares the voltage of the first interface pin with a first voltage threshold to determine whether the first interface pin is electrically floating; or, when the first interface pin is connected with the signal source, the comparison circuit compares the voltage of the first interface pin with a second voltage threshold to determine whether the first interface pin is connected to a ground.

In one embodiment, the threshold voltage range is between the first voltage threshold and the second voltage threshold.

In one embodiment, the transmission interface includes a second interface pin and the interface signal transceiver circuit transmits and/or receives the interface signal through the second interface pin to determine whether the transmission interface is coupled to another transmission interface.

In one embodiment, the transmission interface is an interface compliant with USB type-C specification. In one embodiment, the second interface pin is a configuration channel pin defined in the USB type-C specification.

In one embodiment, when the transmission interface is not coupled to another transmission interface, and the first interface pin is connected with the signal source, when the voltage of the interface pin exceeds the second voltage threshold or the voltage of the interface pin is within the threshold voltage range, the interface signal transceiver circuit is triggered to execute the protection operation.

In one embodiment, the first interface pin and the second interface pin are different types of interface pins.

In one embodiment, when the transmission interface is coupled to the another transmission interface, and the switch connects the first interface pin to the signal source, when the voltage of the first interface pin is within the threshold voltage range, the interface signal transceiver circuit is triggered to execute the protection operation.

In one embodiment, when the voltage of the first interface pin is within the threshold voltage range, it is determined that a foreign object attachment event occurs.

The foreign object may include a conductive fluid or a conductive solid.

In one embodiment, the foreign object can be regarded as including an equivalent circuit between the first interface and a ground, and the equivalent circuit includes an equivalent resistance and an equivalent capacitor.

In one embodiment, the threshold voltage range includes a plurality of sub-ranges, and the sub-ranges respectively correspond to different kinds of foreign objects.

In one embodiment, the comparison circuit starts to determine whether the voltage of the first interface pin is within the threshold voltage range after a predetermined time interval after the first interface pin is connected with the signal source.

In one embodiment, the signal source includes one of the followings: (1) a current source, or (2) a voltage source and a resistor connected in series.

In one embodiment, the protection operation includes: stop transmitting and/or stop receiving the interface signal.

In one embodiment, the interface control circuit further comprises a ground switch coupled between a ground of the interface signal transceiver circuit and the first interface pin, and wherein when the first interface pin is connected with the signal source, the ground switch disconnects the ground of the interface transceiver circuit from the first interface pin.

In one embodiment, the transmission interface has a plurality of ground pins, and the first interface pin is one of the ground pins.

In one embodiment, the comparison circuit includes an analog-to-digital converter.

The objectives, technical details, features, and effects of the present invention will be better understood with regard to the detailed description of the embodiments below.

### BRIEF DESCRIPTION OF THE DRAWINGS

FIG. 1 shows a schematic diagram of an embodiment of an interface control circuit according to the present invention.

FIG. 2 shows a voltage state of a first interface pin in an embodiment according to the present invention.

FIG. 3 shows another embodiment of the present invention.

FIG. 4 shows a schematic diagram of an interface signal transceiver circuit and a transmission interface compliant with USB type-C specification.

FIG. 5 shows a schematic diagram of an embodiment of the threshold voltage range and several sub-ranges thereof according to the present invention.

FIGS. 6A-6C show schematic diagrams of several embodiments of the signal sources according to the present invention.

FIG. 7 shows a schematic diagram of embodiments of the interface control circuit and the ground switch according to the present invention.

FIG. 8 shows a schematic diagram of an embodiment of a comparison circuit according to the present invention.

### DESCRIPTION OF THE PREFERRED EMBODIMENTS

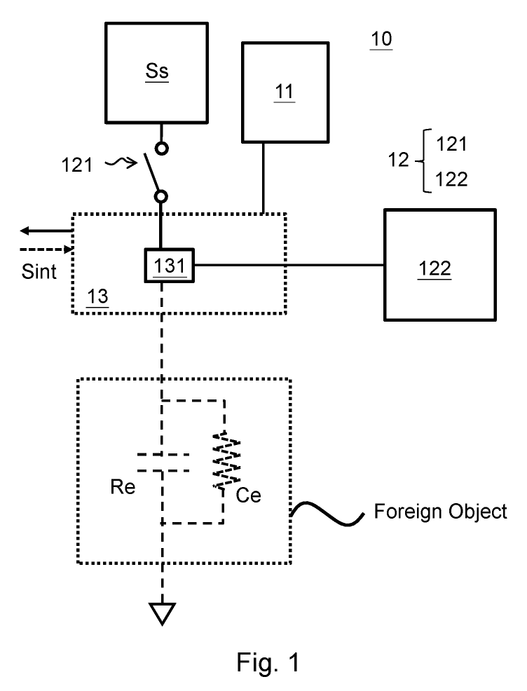

FIG. 1 shows a schematic diagram of an embodiment of an interface control circuit 10 according to one perspective of the present invention. The interface control circuit 10 comprises an interface signal transceiver circuit 11 and a protection circuit 12. The interface signal transceiver circuit 11 is configured to operably transmit or receive an interface signal Sint through a transmission interface 13, wherein the transmission interface 13 includes a first interface pin 131; the protection circuit 12 includes a switch 121 and a comparison circuit 122. The comparison circuit 122 is configured to operably sense a voltage of the first interface pin 131 and determines whether the voltage of the first interface pin 131 falls within a threshold voltage range corresponding to a foreign object attachment event. The switch 121 is configured to operably connect or disconnect the first interface pin 131 with a signal source Ss. When the first interface pin 131 is connected with the signal source Ss and the voltage of the first interface pin 131 is within the voltage threshold range, the interface signal transceiver circuit 11 is triggered to execute a protection operation.

One feature of the interface control circuit 10 is that it is capable of determining whether to execute a protection operation according to whether the voltage of the first interface pin 131, after the first interface pin 131 is connected with the signal source Ss, is within the threshold voltage range. When the voltage of the first interface pin 131 is within the threshold voltage range, it indicates that a foreign object exists between the first interface pin 131 and the ground. Specific examples of the threshold voltage range will be described later.

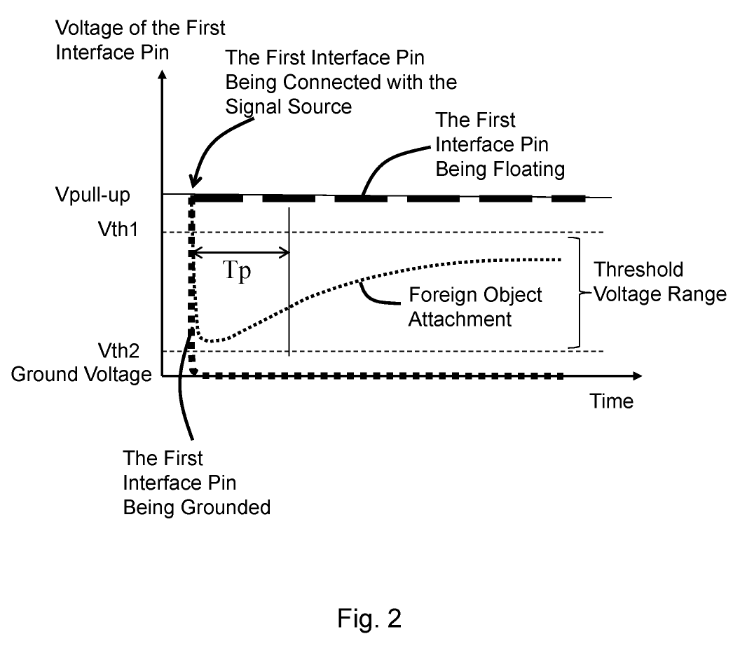

Referring to FIGS. 1 and 2, in one preferable embodiment, when the first interface pin 131 is connected with the signal source Ss, the comparison circuit 122 compares the voltage of the first interface pin 131 with a first voltage threshold Vth1 to determine whether the first interface pin 131 is electrically floating. A voltage Vpull-up is provided by the signal source Ss. When the first interface 131 is electrically floating, the voltage of the first interface 131 corresponds to the voltage Vpull-up, namely, the voltage of the first interface pin 131 is between the voltage Vpull-up and a first voltage threshold Vth1. And/or, when the first interface pin 131 is connected with the signal source Ss, the comparison circuit 122 compares the voltage of the first interface pin 131 with a second voltage threshold Vth2 to determine whether the first interface pin 131 is coupled to ground (this ground for example is a ground pin of another transmission interface). When the first interface pin 131 is coupled to ground, the voltage of the first interface pin 131 corresponds to a ground voltage, namely, the voltage of the first interface pin 131 is between the ground voltage and the second voltage threshold Vth2. However, when the first interface pin 131 is attached with a foreign object, its voltage may be affected by the electrical or electrochemical characteristics of the foreign object. For example, the foreign object may result in an equivalent circuit between the first interface pin 131 and the ground which for example includes an equivalent resistance Re and an equivalent capacitor Ce. When the first interface pin 131 is connected with the signal source Ss, the voltage of the first interface pin 131 is affected by the equivalent circuit so that the voltage of the first interface pin 131 is within a threshold voltage range (between the first voltage threshold Vth1 and the second voltage threshold Vth2). Therefore, after the first interface pin 131 is connected with the signal source Ss and when the voltage of the first interface pin 131 is within the threshold voltage range, it indicates that a foreign object attachment event occurs in the transmission interface 13.

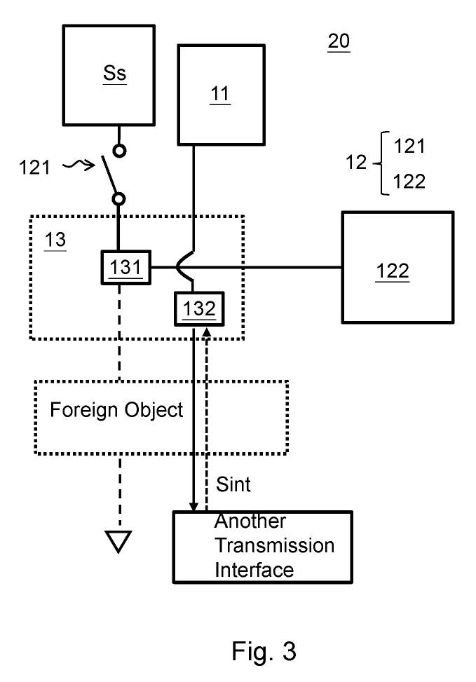

FIG. 3 shows a preferable embodiment of an interface control circuit 20, wherein the transmission interface 13 includes a second interface pin 132 and the interface signal transceiver circuit 11 transmits and/or receives the interface signal Sint through the second interface pin 132 to determine whether the transmission interface 13 is coupled with another transmission interface. In one embodiment, the interface signal Sint may be a low current or a low voltage signal, provided for detecting whether the transmission interface 13 is coupled to another transmission interface.

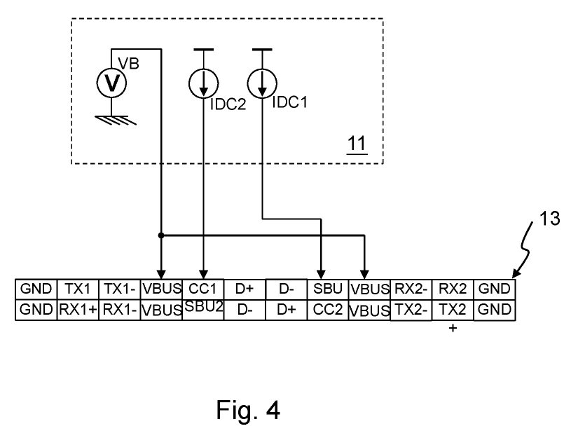

Referring to FIG. 4, in one preferable embodiment, the transmission interface 13 is an interface compliant with the USB type-C interface specification. In one embodiment, the second interface pins CC1, and CC2 are the configuration channel pins, capable of determining whether the transmission interface 13 is coupled with another transmission interface, as well as determining the directions of the transmission interfaces regarding how the two transmission interfaces are connected with each other.

Referring to FIGS. 1 and 2, in one preferable embodiment, when the transmission interface 13 is not coupled to another transmission interface and the first interface pin 131 is connected with the signal source Ss, the voltage of the first interface pin 131 is coupled to the voltage Vpull-up. Without any foreign object being attached, the voltage of the first interface pin 131 should be between the voltage Vpull-up and the first voltage threshold Vth1. However, when the voltage of the first interface pin 131 is within the threshold voltage range (i.e., between the first voltage threshold Vth1 and the second voltage threshold Vth2), there should be a foreign object attached to the first interface pin 131, and the interface signal transceiver circuit 11 is triggered to execute a protection operation to reduce possible effects and damages caused by the foreign object. Or, when the voltage of the first interface pin 131 exceeds the second voltage threshold Vth2 (in the example of FIG. 2, that the voltage of the first interface pin 131 “exceeds” the second voltage threshold Vth2 means that the voltage of the first interface pin 131 is lower than the second voltage threshold Vth2), it indicates another type of abnormal condition, which may be another type of foreign object being attached to the first interface pin 131 so that the voltage of the first interface pin 131 is lower than the second voltage threshold Vth2. In this case, the interface signal transceiver circuit 11 is also triggered to reduce possible effects and damages caused by the foreign object.

It should be noted that: that the voltage of the first interface pin 131 “exceeds” the second voltage threshold Vth2 is a relative concept, which may be “higher” or “lower” depending on the voltage polarity adopted by the transmission interface. For example, in the foregoing embodiment, the voltage Vpull-up provided by the signal source Ss is a positive voltage higher than the ground voltage, and therefore that the voltage of the first interface pin 131 of FIG. 2 exceeds the second voltage threshold Vth2 means that the voltage of the first interface pin 131 is lower than the second voltage threshold Vth2. If the signal source Ss provides the voltage of the first interface pin 131 is a negative voltage lower than the ground voltage, that the voltage of the aforementioned first interface pin 131 exceeds the second voltage threshold Vth2 should mean that the voltage of the first interface pin 131 is higher than the second voltage threshold Vth2.

The first interface pin 131 and the second interface pin 132 of the present invention may be designed according to different specifications, depending on the needs of the use. The first interface pin 131 and the second interface pin 132 may be the same or different types of interface pins. “Different types” mean that the at least one of the following properties is different: voltage specification, current specification, function, input/output direction, etc.

Referring to FIGS. 2 and 3, in one preferable embodiment, when the transmission interface 13 is connected with another transmission interface, the switch 121 controls the first interface pin 131 to be connected with the signal source Ss. When the voltage of the first interface pin 131 is within the threshold voltage range, it indicates that an abnormal condition occurs which may be caused by a foreign object attached between the different transmission interface pins, or other reasons, to affect the voltage of the first interface pin 131. In response, the interface signal transceiver circuit 11 is triggered to execute a protection operation.

As described above, when the voltage of the first interface pin 131 is within the threshold voltage range, it is likely that the transmission interface 13 is attached by a foreign object. However, the reason why the voltage of the first interface pin 131 is within the threshold voltage range is not necessarily due to an attached foreign object, but may be due to other reasons, such as aging of the materials in the transmission interface 13, resulting in failure of some of the insulation functions, so that the voltage of the first interface pin 131 is within the threshold voltage range. Regardless what the reason is, it is still an abnormal condition and a protection operation should be triggered. However, it should be noted that the foreign object attachment event is only one possible reason for the voltage of the first interface pin 131 to be within the threshold voltage range, and it is given only as one example of the abnormal conditions, while the present invention can be applied to not only an abnormal condition caused by foreign object attachment but also abnormal conditions due to other reasons.

The aforementioned foreign object may include a conductive fluid or a conductive solid, and each type of the conductive fluid and the conductive solid may have different electrical characteristics. For example, the conductive fluid may be water, rain, saliva, sea water, beverage, or a combination thereof. For another example, the conductive solid material may be: a hair, a conductive wire, or the like. The user can define the threshold voltage range or define several threshold voltage ranges according to the foreign objects that the transmission interface is most likely to encounter. About the combination of multiple threshold voltage ranges, it will be described in more detail later.

Referring to FIG. 1, in one preferable embodiment, the foreign object is regarded as an equivalent circuit (shown in dashed line) between the first interface pin 131 and the ground. The equivalent circuit includes: an equivalent resistance Re and an equivalent capacitance Ce. Different foreign objects have different electrical behaviors under the same applied voltage. For example, in the same time interval, the equivalent capacitance Ce of different foreign objects has different charging effects, and the voltage effects on the first interface pin 131 are also different so that the type of the foreign objects can be distinguished one from another. In another embodiment, the behavior can be used to determine the severity of the foreign object attachment event and trigger different protection operations of the interface signal transceiver circuit 11. For example, when the influence of the foreign object attachment event is minor, the interface signal transceiver circuit 11 can allow circuit operations by small current or small voltage but stop circuit operations by large current or large voltage. In one embodiment, a warning message may also be issued to notify the user, according to different types of the foreign objects. In one embodiment, all operations of the transmission interface may be stopped.

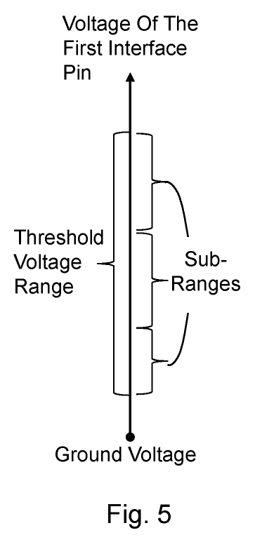

Referring to FIG. 5, in one preferable embodiment, the threshold voltage range may include plural sub-ranges, respectively corresponding to different kinds of foreign objects, or different severities of the foreign object attachment events. For example, when the transmission interface 13 is not coupled to another transmission interface, when the voltage of the first interface pin 131 is more closer to the ground voltage, the foreign object attachment event is more severe. As shown in the figure, each sub-range may be independent from (not overlapped with) another sub-range; or, a sub-range may be partially overlapped with another sub-range.

Referring to FIG. 2, in one preferable embodiment, after the first interface pin 131 is connected with the signal source Ss, the comparison circuit 122 starts to determine whether the voltage of the first interface pin 131 is within the threshold voltage range after a predetermined time interval Tp. When the first interface pin 131 is in contact with a foreign object, the voltage thereof starts to change after the first interface pin 131 is connected with the signal source Ss, and the voltage changes with time; the voltage will generally become stable after a period of time so it is preferred to sense the voltage after the predetermined time interval Tp, to be more accurate. In addition, the foreign object attachment event may occur randomly (at an unpredictable timing), so the sensing action can be performed periodically. In another embodiment, when it is found that the sensed voltage of the first interface pin 131 changes (for example, within the threshold voltage range), at least another sensing action is taken to confirm the correct voltage sensing result. The previous sensing result may be an unstable transient state, so it is preferred that there is a time interval, such as the predetermined time interval Tp, between two subsequent sensing actions to confirm the correct voltage sensing result. In one embodiment, the predetermined time interval Tp is related to the electrical characteristics of the equivalent circuit, for example, but not limited to, its time constant.

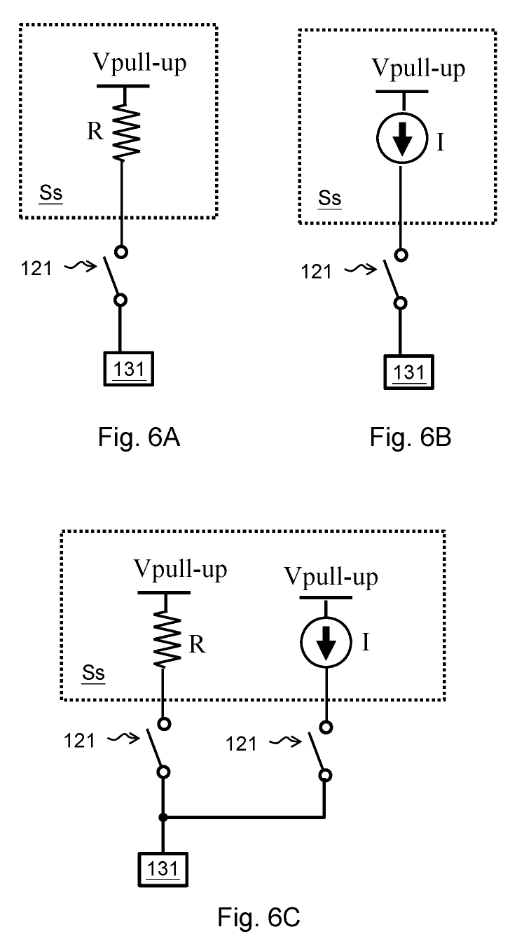

Referring to FIGS. 6A and 6B, in one preferable embodiment, the signal source Ss may include one or more of the followings: (1) a voltage source Vpull-up connected to a resistor R in series (FIG. 6A), or (2) a current source I. (FIG. 6B). In another embodiment, the circuits in FIG. 6A, and 6B can be connected in parallel, as shown in FIG. 6C. Regardless of FIG. 6A, 6B, or 6C, after the first interface pin 131 is connected with the signal source Ss, the comparison circuit 122 can compare the voltage of the first interface pin 131 with the first voltage threshold Vth1 to determine whether the first interface pin 131 is electrically floating. Also, the comparison circuit 122 can compare the voltage of the first interface pin 131 with the second voltage threshold Vth2 to determine whether the first interface pin 131 is coupled to the ground. Certainly, the two comparisons also show whether the voltage of the first interface pin 131 is within the threshold voltage range. In one embodiment, the current source I of FIGS. 6B and 6C does not necessarily need to be connected to the voltage source Vpull-up in series; for example, the current source I itself may include a voltage source terminal to provide a voltage as the voltage of the first interface pin 131.

In FIGS. 6A, 6B, and 6C, a switch (or switches) 121 is/are provided to control the current conduction between the first interface pin 131 and the signal source Ss. However, the location of the switch 121 is not limited to the position as shown, between the signal source Ss and the first interface pin 131; the switch 121 may be disposed between the voltage source Vpull-up and the resistor R in the signal source Ss, or between the voltage source Vpull-up and the current source I in the signal source Ss, which also can achieve the effect of controlling the current conduction between the first interface pin 131 and the signal source Ss.

In one preferable embodiment, the aforementioned protection operation includes: stopping the transmission and stopping the reception of the interface signal Sint, that is, the interface signal transceiver circuit 11 is triggered to stop the transmission interface 13 from transmitting and/or receiving the interface signal Sint. Referring to the embodiment of FIG. 4, the interface signal Sint which is stopped to transmit/receive may include a power supply voltage VBUS or other communication interface signals.

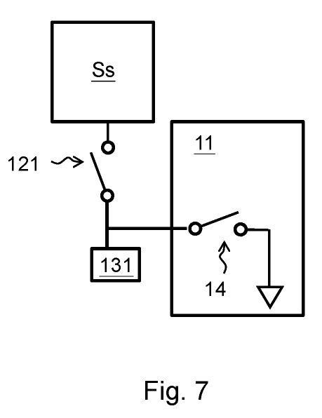

FIG. 7 shows that in one preferable embodiment, the interface control circuit further includes a ground switch 14 (in the shown embodiment, the ground switch 14 is located inside the interface signal transceiver circuit 11, but the present invention is not limited to such an embodiment); the ground switch 14 is coupled between the ground of the interface signal transceiver circuit 11 and the first interface pin 131. When the first interface pin 131 is connected to the signal source Ss, the grounding switch 14 disconnects the ground of the interface signal transceiver circuit 11 from the first interface pin 131. In one embodiment, the first interface pin 131 is one of the ground (GND) pins. In one embodiment, when the first interface pin 131 is not connected with the signal source Ss, the grounding switch 14 connects the ground of the interface signal transceiver circuit 11 to the first interface pin 131.

As described above, the transmission interface 13 may have plural ground pins, and in one embodiment, the first interface pin 131 is one of the plural ground pins. In another embodiment, the first interface pin 131 is a pin other than the ground pin. For example, the first interface pin 131 may be a power supply voltage (VBUS) pin. The power supply voltage pin also has relatively simple electrical characteristics similar to the grounding pin, so it is easy to set threshold voltage range. Similar to the above embodiment, there can be a switch to connect or disconnect the first interface pin 131 with or from the power supply voltage.

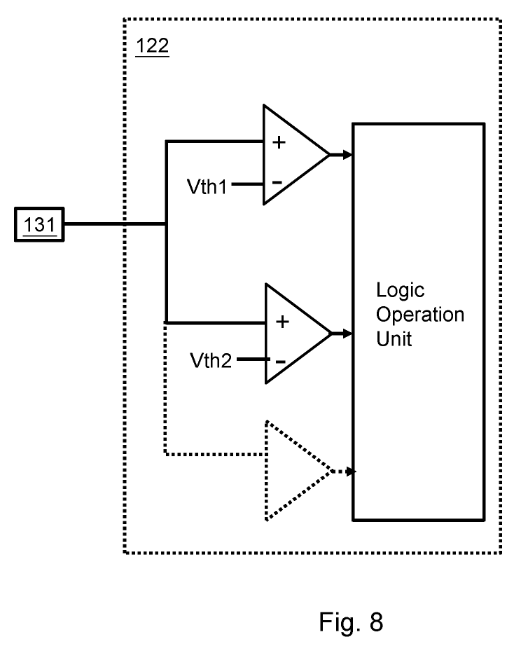

In one preferable embodiment, the comparison circuit 122 may include at least two comparators, or an analog to digital converter. Referring to FIG. 8, in this embodiment, two comparators in the comparison circuit 122 respectively compare the voltage of the first interface pin 131 with the first voltage threshold Vth1 and the second voltage threshold Vth2 to determine whether the first interface pin 131 is floating, grounded, or within the threshold voltage range. In addition, the comparison circuit 122 may include more comparators to determine which sub-range the voltage of the first interface pin 131 is within if required. In the embodiment wherein the comparison circuit 122 includes the analog to digital converter, the comparison circuit 122 can determine whether the voltage is floating, grounded, or within the threshold voltage range according to the sensed voltage of the first interface pin 131. And, the comparison circuit 122 can determine which sub-range the voltage of the first interface pin 131 is within. In one embodiment, the comparison circuit 122 may include only one comparator whose one input switches between two threshold voltages (for example, the first voltage threshold Vth1 and the second voltage threshold Vth2) in a multiplexing manner.

The present invention has been described in considerable detail with reference to certain preferred embodiments thereof. It should be understood that the description is for illustrative purpose, not for limiting the scope of the present invention. It is not limited for each of the embodiments described hereinbefore to be used alone; under the spirit of the present invention, two or more of the embodiments described hereinbefore can be used in combination. In addition, various variations and modifications can be conceived by those skilled in the art under the same spirit of the present invention. Therefore, the scope of the present invention should cover all such variations and modifications.

What is claimed is:

1. An interface control circuit, comprising:
an interface signal transceiver circuit, configured to operably transmit and/or receive an interface signal through a transmission interface, wherein the transmission interface includes a first interface pin; and
a protection circuit, which includes:
a switch, configured to control whether the first interface pin is connected with a signal source; and
a comparison circuit, configured to sense a voltage of the first interface pin, and determine whether the voltage of the first interface pin is within a threshold voltage range which corresponds to a foreign object attachment event that a foreign object is attached to the first interface pin;
wherein when the first interface pin is connected with the signal source and the voltage of the first interface pin is within the voltage threshold range, the interface signal transceiver circuit is triggered to execute a protection operation.

2. The interface control circuit of claim 1, wherein when the first interface pin is connected with the signal source, the comparison circuit compares the voltage of the first interface pin with a first voltage threshold to determine whether the first interface pin is electrically floating; or, when the first interface pin is connected with the signal source, the comparison circuit compares the voltage of the first interface pin with a second voltage threshold to determine whether the first interface pin is connected to a ground.

3. The interface control circuit of claim 2, wherein the threshold voltage range is between the first voltage threshold and the second voltage threshold.

4. The interface control circuit of claim 2, wherein the transmission interface includes a second interface pin and the interface signal transceiver circuit transmits and/or receives the interface signal through the second interface pin to determine whether the transmission interface is coupled to another transmission interface.

5. The interface control circuit of claim 1, wherein the transmission interface is an interface compliant with USB type-C specification.

6. The interface control circuit of claim 4, wherein the transmission interface is an interface compliant with USB type-C specification, and the second interface pin is a configuration channel pin defined in the USB type-C specification.

7. The interface control circuit of claim 4, wherein when the transmission interface is not coupled to another transmission interface, and the first interface pin is connected with the signal source, when the voltage of the interface pin exceeds the second voltage threshold or the voltage of the interface pin is within the threshold voltage range, the interface signal transceiver circuit is triggered to execute the protection operation.

8. The interface control circuit of claim 4, wherein the first interface pin and the second interface pin are different types of interface pins.

9. The interface control circuit of claim 4, wherein when the transmission interface is coupled to the another transmission interface, and the switch connects the first interface pin to the signal source, when the voltage of the first interface pin is within the threshold voltage range, the interface signal transceiver circuit is triggered to execute the protection operation.

10. The interface control circuit of claim 1, wherein when the voltage of the first interface pin is within the threshold voltage range, it is determined that a foreign object attachment event occurs.

11. The interface control circuit of claim 1, wherein the foreign object includes a conductive fluid or a conductive solid.

12. The interface control circuit of claim 11, wherein the foreign object includes an equivalent circuit between the first interface and a ground, and the equivalent circuit includes an equivalent resistance and an equivalent capacitor.

13. The interface control circuit of claim 11, wherein the threshold voltage range includes a plurality of sub-ranges, and the sub-ranges respectively correspond to different kinds of foreign objects.

14. The interface control circuit of claim 1, wherein the comparison circuit starts to determine whether the voltage of the first interface pin is within the threshold voltage range after a predetermined time interval after the first interface pin is connected with the signal source.

15. The interface control circuit of claim 1, wherein the signal source includes one of the followings: (1) a current source, or (2) a voltage source and a resistor connected in series.

16. The interface control circuit of claim 1, wherein the protection operation includes: stop transmitting and/or stop receiving the interface signal.

17. The interface control circuit of claim 1, further comprising a ground switch coupled between a ground of the interface signal transceiver circuit and the first interface pin, and wherein when the first interface pin is connected with the signal source, the ground switch disconnects the ground of the interface transceiver circuit from the first interface pin.

18. The interface control circuit of claim 1, wherein the transmission interface has a plurality of ground pins, and the first interface pin is one of the ground pins.

19. The interface control circuit of claim 1, wherein the comparison circuit includes an analog-to-digital converter.
